(19) United States
(12) Patent Application Publication
(10) Pub. No.: US 2017/0287106 A1
(43) Pub. Date: Oct. 5, 2017

(54) GRAPHICS SYSTEM AND METHOD FOR GENERATING A BLENDED IMAGE USING CONTENT HINTS

(71) Applicant: MediaTek Inc., Hsinchu (TW)

(72) Inventors: Chang-Chu Liu, Hsinchu (TW); Jun-Jie Jiang, Zhubei (TW); Chiung-Fu Chen, Hsinchu (TW); You-Min Yeh, Taipei (TW)

(21) Appl. No.: 15/630,252

(22) Filed: Jun. 22, 2017

Related U.S. Application Data
(63) Continuation-in-part of application No. 15/137,418, filed on Apr. 25, 2016.
(60) Provisional application No. 62/366,647, filed on Jul. 26, 2016.
(60) Provisional application No. 62/157,066, filed on May 5, 2015.

(51) Int. Cl. G06T 1/60; G06T 1/20; G06T 11/60

(52) U.S. Cl. CPC G06T 1/60; G06T 11/60; G06T 1/20; G06T 2210/62

(57) ABSTRACT

A device generates blended frames, with each blended frame composed of multiple image layers and each image layer composed of multiple regions. The device includes display hardware. The display hardware retrieves a given image layer in a current frame from a memory. Based on at least content hints generated at the display hardware for the given image layer in the current frame, the display hardware makes a determination of whether to skip access to the memory for retrieving each region of each image layer in a next frame that is immediately after the current frame, and accesses the memory for the next frame according to the determination.

### CROSS-REFERENCE TO RELATED APPLICATIONS

This application claims the benefit of U.S. Provisional Application No. 62/366,647 filed on Jul. 26, 2016, and is a continuation-in-part application of U.S. patent application Ser. No. 15/137,418 filed on Apr. 25, 2016, which claims the benefit of U.S. Provisional Application No. 62/157,066, filed on May 5, 2015.

### TECHNICAL FIELD

Embodiments of the invention relate to graphics processing of overlay image layers to generate a blended image.

### BACKGROUND

Mobile devices on the market are usually equipped with a graphics system such as a graphics processing unit (GPU) and other image producing units for generating image layers that can be overlaid by a compositor to form a blended frame. Conventionally, all pixels of the overlay image layers are retrieved from a frame buffer when generating the blended image, and thus a huge amount of memory bandwidth is required.

Accordingly, there is demand for a graphics system and an associated method for generating a blended image with efficient memory access.

### SUMMARY

In one embodiment, a method is provided for a device to generate blended frames. Each blended frame is composed of a plurality of image layers and each image layer is composed of a plurality of regions. The method comprises: retrieving, by display hardware of the device, a given image layer in a current frame from a memory; making a determination of whether to skip access to the memory for retrieving each region of each image layer in a next frame that is immediately after the current frame, based on at least content hints generated at the display hardware for the given image layer in the current frame; and accessing the memory by the display hardware for the next frame according to the determination.

In another embodiment, a device is provided to generate blended frames. Each blended frame is composed of a plurality of image layers and each image layer is composed of a plurality of regions. The device comprises: circuitry that includes a plurality of image producers to produce the image layers; a memory to store the image layers; and display hardware coupled to the circuitry and the memory. The display hardware is operative to: retrieve a given image layer in a current frame from the memory; make a determination of whether to skip access to the memory for retrieving each region of each image layer in a next frame that is immediately after the current frame, based on at least content hints generated at the display hardware for the given image layer in the current frame; and access the memory for the next frame according to the determination.

The embodiments of the invention enable a device to reduce memory access when composing a blended frame from multiple image layers. Advantages of the embodiments will be explained in detail in the following descriptions.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 illustrates an example of a system for generating a blended frame according to one embodiment.

FIG. 2 illustrates a diagram of a display engine coupled to an analyzer for generating content hints according to one embodiment.

FIG. 3A is a diagram illustrating an example of image layers and respective content hints according to one embodiment.

FIG. 3B is a diagram illustrating composition of three image layers according to one embodiment.

FIG. 4A illustrates an example of three image layers to be overlaid to form a blended frame according to one embodiment.

FIGS. 4B, 4C and 4D are tables showing reduction in memory bandwidth when different content hints are used in conjunction with the example of FIG. 4A.

FIG. 5 is a flow diagram illustrating a method for generating blended frames according to one embodiment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

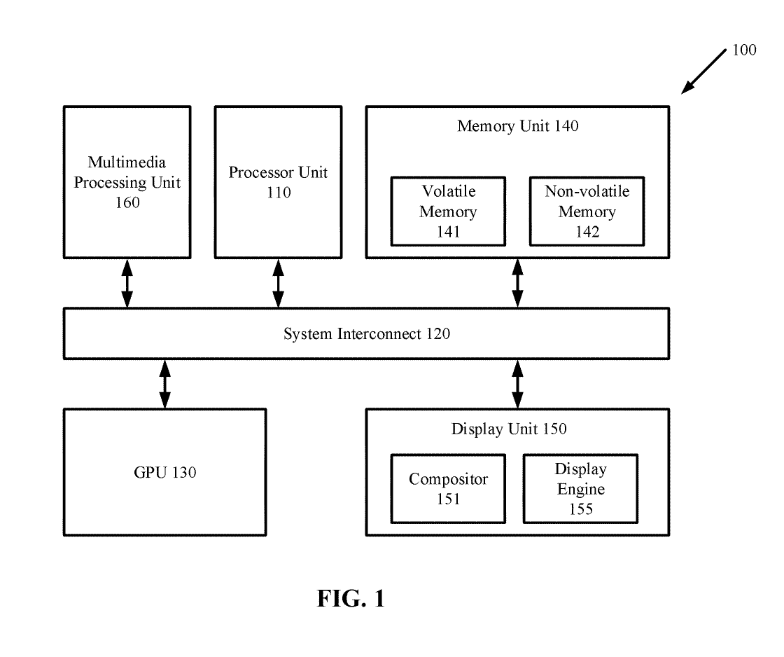

FIG. 1 is a diagram of a system 100 according to one embodiment. The system 100 can be a mobile device (e.g., a tablet computer, a smartphone, or a wearable computing device), a laptop computer, or any computing or graphics device capable of generating or acquiring images as well as displaying images. The system 100 can be implemented as multiple chips or a single chip such as a system-on-a-chip (SOC). In one embodiment, the system 100 includes a processor unit 110 which may further includes one or more processors or cores, a graphics processing units (GPU) 130 which may further includes one or more graphics processors or cores, a memory unit 140, a display unit 150 and an multimedia processing unit 160 (e.g., camera, image decoder, video decoder, and the like). The system 100 also includes a system interconnect 120 which interconnects all of the aforementioned units 110, 130, 140, 150 and 160. It is understood that the system 100 may include additional elements, such as digital signal processors (DSPs), antennas, and other input/output units, which are omitted herein for simplicity of illustration.

The processor unit 110 may include, but are not limited to, one or more general-purpose processors (e.g., central processing units (CPUs)). The memory unit 140, for example, may include a volatile memory 141 and a non-volatile memory 142. The volatile memory 141 may be a dynamic random access memory (DRAM) or a static random access memory (SRAM), and the non-volatile memory 142 may be a flash memory, a hard disk, a solid-state disk (SSD), etc. For example, the program codes of the applications for use in the system 100 can be pre-stored in the non-volatile memory 142. The processor 110 may load program codes of applications from the non-volatile memory 142 to the volatile memory 141, and execute the program code of the applications. It is noted that although the volatile memory 141 and the non-volatile memory 142 are illustrated as one memory unit, they can be implemented separately as several memory units. In addition, different numbers of volatile memory 141 and/or non-volatile memory 142 can be also implemented in different embodiments.

The system 100 may include a plurality of image producers, including but not limited to: the processor unit 110, the GPU 130, and the multimedia processing unit 160. The processor unit 110 may generate graphics data to be displayed by the display unit 150, and may also command the GPU 130 to generate graphics data to be displayed. Additionally, the multimedia processing unit 160 may acquire and/or generate multimedia data streams to be displayed. Some of these image producers may be capable of producing content hints, and some of them may not be, as will be described in detail later.

The display unit 150 may include a display engine 155, which is a piece of hardware controlling a driving circuit (not shown) and a display screen (not shown) where frames are to be displayed. The display engine 155 also controls access to the memory unit 140. The display unit 150 may further include a compositor 151. The compositor 151 is a piece of hardware which can be configured to generate a resulting blended frame (also referred to as “frame”) according to images or graphics data, such as a plurality of overlay image layers (also referred to as “image layers”).

Each of the image layers may be divided into a plurality of regions (e.g., tiles), and each region of each image layer includes at least one pixel. The regions of an image layer can be equally-sized or non-equally-sized. The image layers may be divided into regions in the same or different ways; that is, each image layer may be divided into different sets of regions (R₁, R₂, R₃, . . . , R_{N}), with each region being identified by its location in the resulting blended frame.

In one embodiment, the content hint for a region of an image layer may include one or more types, including but not limited to: an alpha hint, a dirtiness hint, a constant hint, and other hints indicating characteristics of the region. The content hints may be generated by an image producer if the image producer (e.g., a CPU or a GPU) is capable of producing content hints. If an image producer of an image layer is incapable of producing content hints or some types of content hints, the display engine 155 may generate a content hint (including one or more types) for each region of the image layer.

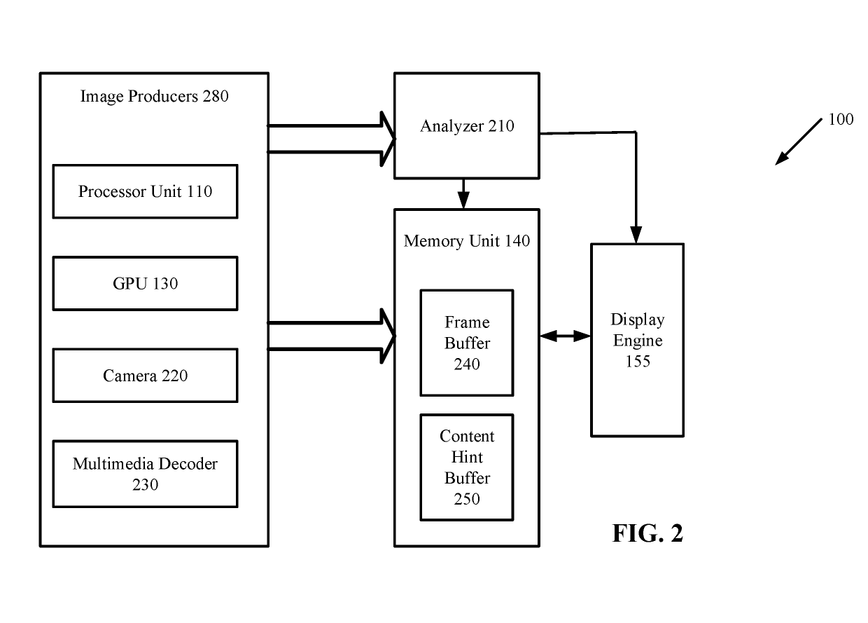

FIG. 2 illustrates a diagram of the display engine 155 coupled to an analyzer 210 for generating content hints in the system 100 according to one embodiment. The analyzer 210 may be implemented in software, hardware, or a combination of hardware and software. Although in FIG. 2 the analyzer 210 and the display engine 155 are shown as two separate units, in some embodiments the analyzer 210 may be part of the display engine 155. The analyzer 210 may receive pixel values from image producers 280 and provide analysis results and/or some types of content hints to the display engine 155. The system 100 may include two categories of image producers 280. The image producers 280 in a first category, such as the processor unit 110 and the GPU 130, may generate content hints for the image layers (“first image layers”) that they produce, and store the pixel values of the first image layers as well as their respective content hints in the memory unit 140. The image producers 280 in a second category, such as a camera 220 and a multimedia decoder 230, may be unable to generate content hints, or at least some types of content hints, for the image layers (“second image layers”) that they produce. Although one camera and one multimedia decoder are shown, it is understood that the system 100 may include any number of cameras and multimedia decoders. The second category of image producers 280 also store the pixel values of the second image layers in the memory unit 140. The content hints, or at least some types of content hints, of the second image layers may be produced by the display engine 155 according to the analysis result of the analyzer 210. Alternatively, the analyzer 210 may generate some types of content hints. The system 100 may include additional image producers that do not generate at least some types of content hints.

In one embodiment, for each image layer that does not have content hints or at least some types of content hints, the analyzer 210 may generate the missing content hints and store the content hints for its own use at a later time; for example, the content hints (e.g., alpha hints and constant hints) generated by the analyzer 210 from a given image layer of frame N may be used for frame (N+1) (i.e., the next frame) if there is no change in the given image layer from frame N to frame (N+1). The display engine 155 may also store the content hints for other components in the system 100 to facilitate the operations of these other components.

In one embodiment, for each image layer that does not have content hints or at least some types of content hints, the analyzer 210 may generate the missing content hints and provide the content hints to the display engine 155. For example, the content hints (e.g., dirtiness hints and constant hints) generated by the analyzer 210 from a given image layer of frame N may be used for the same frame N. The analyzer 210 may also store the content hints for other components in the system 100 to facilitate the operations of these other components.

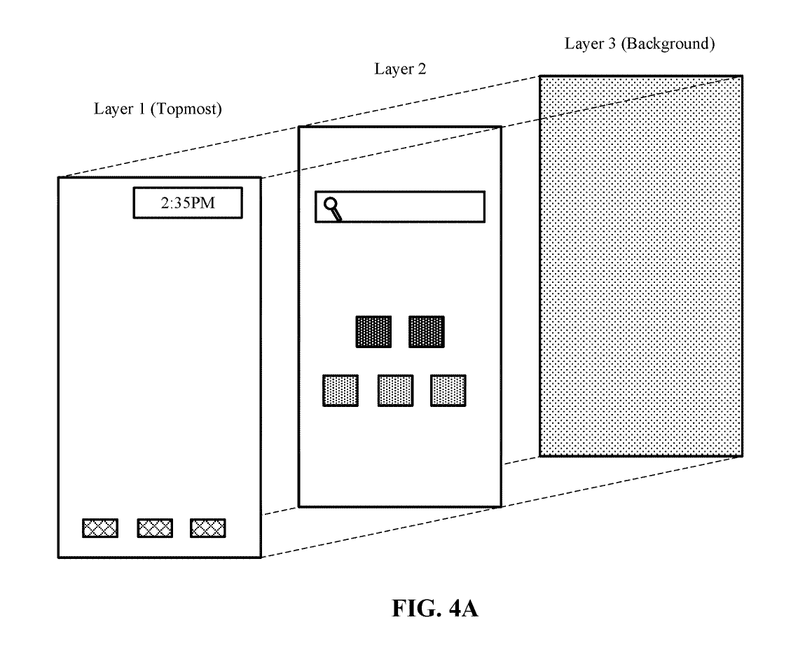

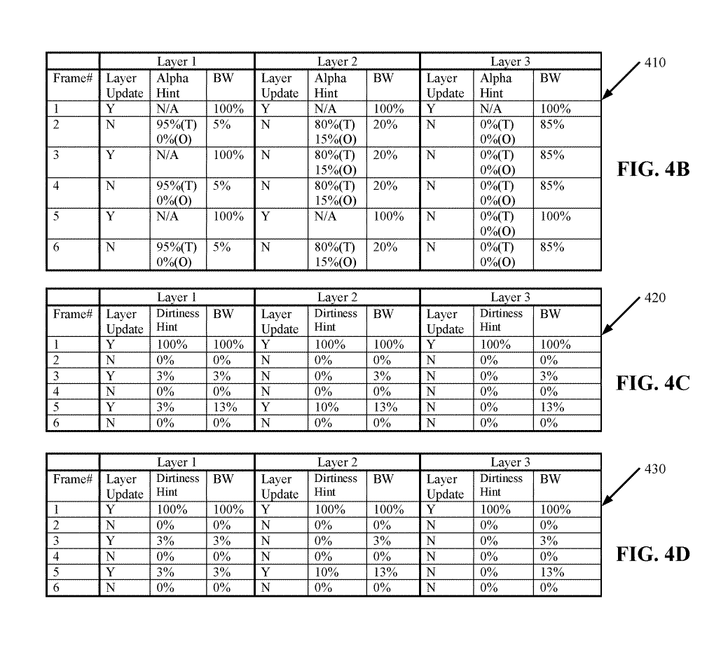

To generate a content hint for a region of an image layer, the display engine 155 first retrieves the pixels values of the region of the image layer from the memory unit 140 (e.g., a frame buffer 240). According to the analysis result generated by the analyzer 210, the analyzer 210 or the display engine 155 generates a content hint for the region of the image layer. The content hints generated from the entire image layer of a current frame can be used to reduce memory access for the image layer in the next frame if there is no update to the image layer in the next frame. If there is an update to the image layer in the next frame, the display engine 155 may use a combination of different types of content hints among image layers to reduce memory access, as will be illustrated in the example of FIG. 4D.

In one embodiment, the image layers to be displayed can be stored in the frame buffer 240 in the memory unit 140, and the content hints associated with these image layers can be stored in a content hint buffer 250 in the memory unit 140. According to the content hints, the display engine 155 may obtain the pixel values of each image layer as needed from the frame buffer 140, and the compositor 151 may generate a blended image using the pixel data. Although only one frame buffer and one content hint buffer are shown, it is understood that the memory unit 140 may include any number of frame buffers for storing the image layers, and any number of content hint buffers for storing the content hints. In some embodiment, the image layers and their respective content hints may be store in the same buffer in the memory unit 140.

In the following, it is understood that “retrieving a region of a memory layer” and “retrieving a memory layer” refer to “retrieving pixel values” of a region of a memory layer and a memory layer, respectively. Further, a first region of a first image layer is “co-located” with a second region of a second image layer if both regions occupy the same location in a resulting blended frame. Thus, the second region of the second image layer may be referred to as a “co-located region” with respect to the first region of the first image layer. Additionally, if the first image layer is on top of the second image layer in the resulting blended frame, the co-located (i.e., second) region of the second image layer is referred to as being “directly behind” the first region of the first image layer.

As mentioned above, one type of content hint is the alpha hint. The alpha hint is a value; e.g., a value of one indicates opaqueness, a value of zero indicates transparency, and a value between zero and one indicates translucency. When the alpha hint of a region of a given image layer indicates the region as being a transparent region, the display engine 155 can skip retrieving the pixel values of the transparent region of the given image layer. When the alpha hint of a region of a given image layer indicates the region as being an opaque region, the display engine 155 can skip retrieving the pixel values of the co-located region of a next image layer directly behind the opaque region of the given image layer. If there are multiple image layers behind the given image layer, the display engine 155 can skip retrieving the pixel values of the co-located regions of each of these multiple image layers.

Another type of content hint is the dirtiness hint. When the dirtiness hint of a region of a given image layer indicates the region as being non-dirty at frame N, it means that pixel values of the region of the given image layer for frame N are the same as the pixel values of the region of the given image layer for frame (N−1) (i.e., the previous frame). Thus, for the resulting blended frames stored in memory or used for other processing or analysis (e.g. motion estimation and picture quality processing), the display engine 155 can skip retrieving the non-dirty region of the given image layer if all co-located regions are non-dirty, or a combination of content hints indicates this possibility. When the dirtiness hint of a region of a given image layer indicates the region as being dirty at frame N, it means that at least one pixel value of the region of the given image layer for frame N is different from the pixel value of the region of the given image layer for frame (N−1). Accordingly, the display engine 155 cannot skip retrieving the region of the given image layer for frame N.

Yet another type of content hint is the constant hint. When the constant hint of a region of a given image layer for a frame indicates a constant region, it means that the pixel values in the region of the given image layer are the same. Thus, the display engine 155 can retrieve one pixel value for each region and skip the rest in that region of the given image layer. In contrast, when the constant hint of a region of a given image layer indicates a non-constant region, it means that the pixel values in the region of the given image layer are not the same.

It is noted that in some embodiments, multiple types of content hints can be stored for each region of each image layer. For example, the content hint of a given region of an image layer may record any combination of alpha hint, dirtiness hint and constant hint. In one embodiment, it can be determined whether to retrieve any region of any image layer in a frame by using a combination of multiple types of content hints.

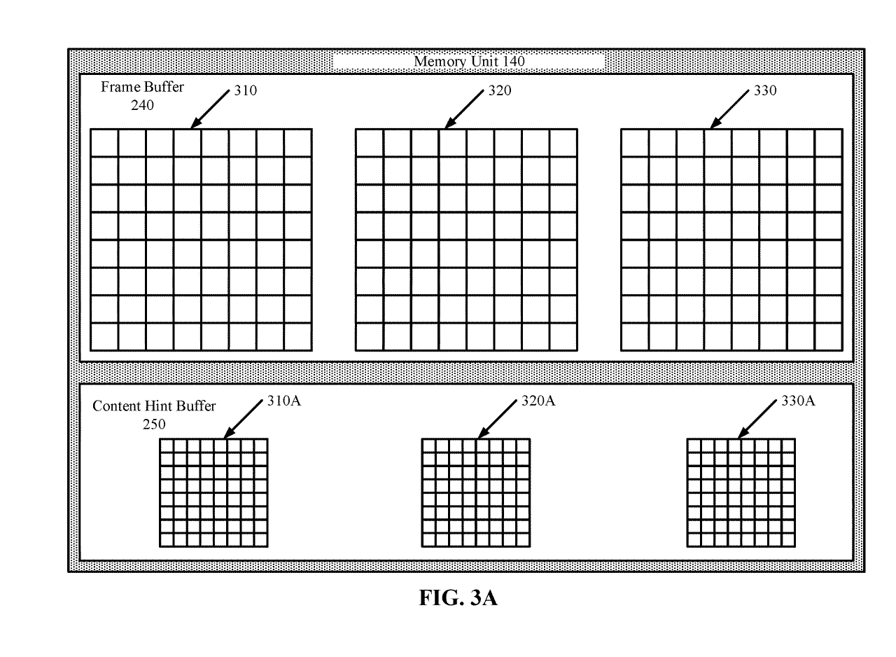

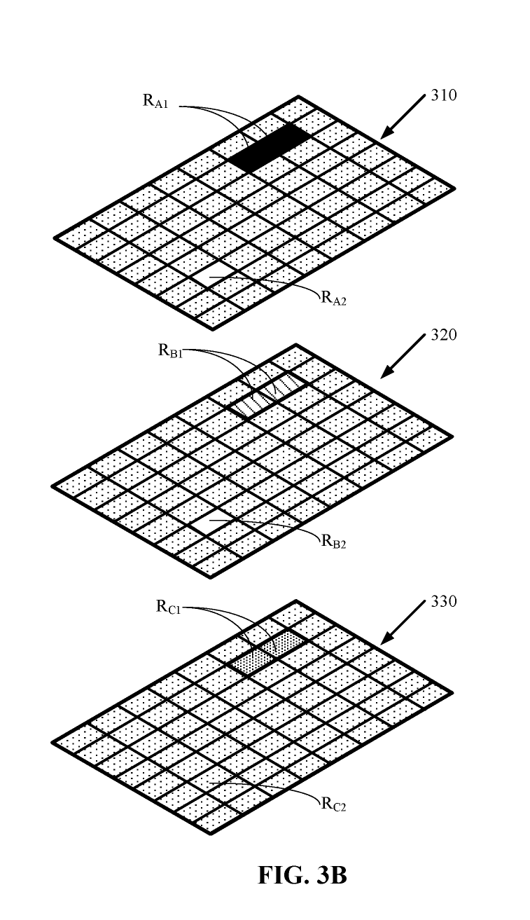

FIG. 3A is a diagram illustrating an example of image layers and respective content hints according to one embodiment. In this example, there are three image layers including an image layer 310, an image layer 320, and an image layer 330. It is understood that any number of image layers can be used in connection with content hints and image composition. The image layer 310 is the topmost image layer, and the image layer 330 is the bottom image layer. Each square as shown in FIG. 3A in the image layers 310, 320 and 330 represents a region. The image layers 310, 320, and 330 (more specifically, the pixel values of these image layers) can be stored in the frame buffer 240.

Content hints 310A, 320A and 330A are associated with image layers 310, 320 and 330, respectively. Each square as shown in FIG. 3A in the content hints 310A, 320A and 330A represents the content hint for a region that corresponds to a region of the respective image layers 310, 320 and 330. The content hints 310A, 320A and 330A (more specifically, the content hint values of the respective image layers 310, 320 and 330) can be stored in the content hint buffer 250. Alternatively, for content hints generated by the analyzer 210 or the display engine 155, they may be internally stored in the analyzer 210 or display engine 155 and ready for immediate use.

FIG. 3B is a diagram illustrating composition of the three image layers 310, 320 and 330 according to one embodiment. In this example, only alpha hints are illustrated as the content hints. Before an image layer is retrieved from the memory unit 140 to form a blended frame, the display engine 155 may obtain the stored alpha hints to determine whether it can skip retrieving one or more regions of the image layer from the memory unit 140. The determination may be made according to the alpha hint for each region of the image layer.

In an example case, the alpha hints for regions R_{A1} (composed of two adjacent regions) of the topmost image layer 310 indicate that the regions R_{A1} are opaque regions. Thus, the pixel values of regions R_{A1} may fully overwrite the pixel values of the co-located regions R_{B1} and R_{C1} of the image layers 320 and 330 that are directly behind the image layer 310. Accordingly, the display engine 155 may skip memory access for regions R_{B1} and R_{C1} from the memory unit 140 for generating the blended image, so that the required memory bandwidth can be reduced.

In another example case, the alpha hints of regions R_{A2} and R_{B2} of the top two image layers 310 and 320 indicate that regions R_{A2} and R_{B2} are transparent regions. It means that the image content of regions R_{A2} and R_{B2} can be allowed not to be rendered in the resulting blended frame. Accordingly, the display engine 155 may skip memory access for regions R_{A2} and R_{B2} from the memory unit 140, so that the required memory bandwidth can be reduced.

The following description focuses on the second category of image producers, which do not generate at least some types of content hints for the image layers that they produce. In the following, alpha hints are used as a non-limiting example of the content hint that is not produced by the second category of image producers.

In one embodiment, alpha hints for an image layer in a current frame may be generated by the display engine 155 after the image layer is retrieved from memory. If the image layer is not updated in the next frame, the same alpha hints can be used to reduce memory access for the image layer in the next frame. If the image layer in the next frame is updated in only a few regions, the alpha hints generated for the image layer in the current frame can be used to reduce memory access for the non-dirty (i.e., non-updated) regions. The dirtiness hint associated with a given region of the image layer in the next frame indicates whether there is an update to the given region in the next frame. Thus, the alpha hints of the current frame may be used in conjunction with the dirtiness hints of the next frame for the display engine 155 to determine for each image layer whether it can skip retrieving some pixel values for that image layer in the next frame.

FIGS. 4A-4D illustrate an example of memory bandwidth reduction from using the content hints; in particular, the alpha hint and/or the dirtiness hint. As used herein, “memory bandwidth reduction” is used interchangeably with “memory access reduction.” FIG. 4A shows three overlay image layers: Layer-1 (topmost), Layer-2 and Layer-3 (background), which are to be overlaid to form a blended frame. For a sequence of six frames to be used as an example below, 95% of the regions in Layer-1 are transparent regions (indicated by “T” in Table 410 of FIG. 4B), 80% of the regions in Layer-2 are transparent regions, 15% of the regions in Layer-2 are opaque regions (indicated by “O” in Table 410), and Layer-3 has no transparent regions. To simplify the description, in this example the respective percentages of transparent regions and opaque regions in each image layer stay unchanged throughout the six frames.

FIG. 4B is a Table 410 showing the memory bandwidth reduction when alpha hints generated by the display engine 155 are used in conjunction with the example of FIG. 4A. The display engine 155 receives a signal (i.e., Layer Update), e.g., from the software subsystem, usually when an image layer is updated. The signal indicates that at least one pixel value in the image layer has changed. As mentioned before, the alpha hints generated by the display engine 155 has one frame delay, because the display engine 155 needs to retrieve an image layer of frame N to calculate the alpha hints of the image layer. The alpha hints calculated from the image layer of frame N is then ready for potential memory bandwidth reduction at frame (N+1). FIGS. 4B-4D illustrate scenarios in which Layer-1 is updated every other frame, Layer-2 is updated at frame 1 and frame 5, and Layer-3 is updated at frame 1 only. The alpha hints for an image layer are ready to be used one frame after an update to the image layer, and can continue to be used until the next update to the image layer occurs.

In one embodiment where the display engine 155 generates and uses alpha hints to reduce memory access, Table 410 of FIG. 4B shows that for Layer-1, the alpha hints are ready at frames 2, 4 and 6 (one frame after an update to Layer-1). The alpha hints for Layer-1 indicate that 95% of Layer-1 is transparent and 0% is opaque. As a result of the transparent regions, the memory bandwidth at frames 2, 4 and 6 for Layer-1 is 5% of a full layer access. For Layer-2, the alpha hints are ready at frames 2, 3, 4 and 6 (at least one frame after an update to Layer-2). The alpha hints for Layer-2 indicate that 80% of Layer-2 is transparent and 15% is opaque. As a result of the transparent regions, the memory bandwidth at frames 2, 3, 4 and 6 for Layer-2 is 20% of a full layer access. For Layer-3, its alpha hints are ready at frames 2-6 (at least one frame after an update to Layer-3). The alpha hints for Layer-3 indicate that 0% of Layer-3 is transparent and 0% is opaque. Because 15% of the regions in Layer-2 are opaque as shown in the alpha hints for Layer-2 at frames 2, 3, 4 and 6, the memory bandwidth at frames 2, 3, 4 and 6 for Layer-3 is 85% of a full layer access.

FIG. 4C is a Table 420 showing the memory bandwidth reduction when dirtiness hints are used in conjunction with the example of FIG. 4A. In this example, the display engine 155 is required to update only changed regions of the resulting blended frame. The dirtiness hints may be generated by software, e.g., the analyzer 210 (FIG. 2) or other image producers, e.g., the GPU 130 (FIG. 2). In contrast to the alpha hints generated by the display engine 155, the dirtiness hints for an image layer that is updated at frame N are ready for use at frame N. The Layer Update signal mentioned above in connection with Table 410 only indicates that at least one pixel value in an entire image layer is updated. The dirtiness hint has a finer granularity at the level of a region of an image layer. For example, for Layer-1 at frames 3 and 5, the dirtiness hints indicate that only 3% of the regions in Layer-1 is updated. For Layer-2 at frame 5, the dirtiness hints indicate that only 10% of the regions in Layer-2 is updated. In this example it is assumed that alpha hints are not used or otherwise not available. Thus, whenever a region of an image layer is updated, the respective co-located regions in all other image layers need to be retrieved to form a blended frame. For example at frame 4, Layer-1 has a 3% update and Layer-2 has a 10% update. Each of the three image layers of frame 4 has memory access of 3%+10%=13%, meaning that 13% of the regions in the respective image layers needs memory access. This is a significant reduction compared to a full-layer access of 100% for each image layer.

FIG. 4D is a Table 430 showing the memory bandwidth reduction when both alpha hints and dirtiness hints are used in conjunction with the example of FIG. 4A. It can be seen that at frame 5, the display engine 155 only needs to access 3% of Layer-1, under the assumption in this example that the 10% update in Layer-2 falls into the transparent regions of Layer-1. Thus, using both alpha hints and dirtiness hints can further reduce memory access.

When generating a blended frame, the display engine 155 may utilize the available information to determine whether to retrieve or skip memory access for each region of each image layer. A blended frame may include one or more image layers that come with content hints generated by their respective image producers, one or more image layers with content hints generated by the display engine 155, and/or one or more image layers with content hints generated by the analyzer 210. The display engine 155 and the analyzer 210 may supplement the missing content hints or the types of content hints that are not generated by the image producers, and the display engine 155 combine the different content hints to reduce memory access.

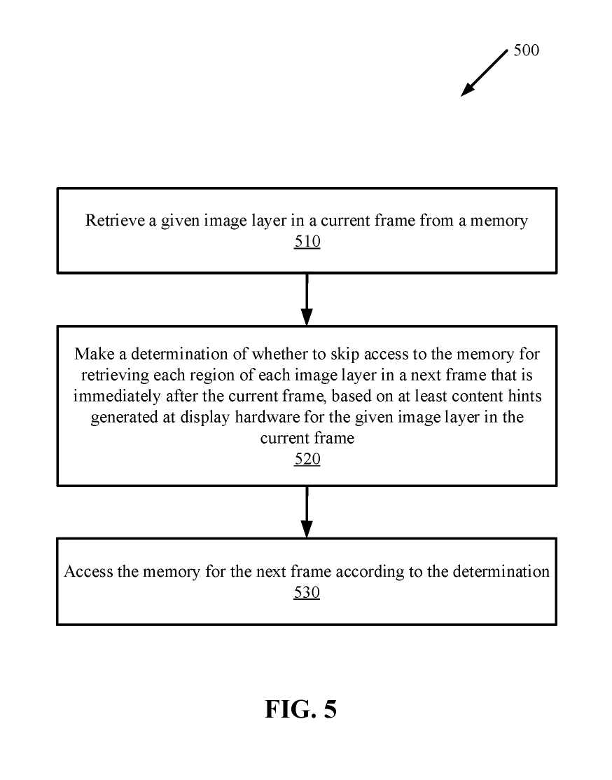

FIG. 5 is a flow diagram illustrating a method 500 for a device to generate blended frames. Each blended frame is composed of a plurality of image layers and each image layer is composed of a plurality of regions. In one embodiment, the method 500 may be performed by a processing system, such as the system 100 of FIG. 1. In one embodiment, the method 500 may be performed by the display engine 155 of FIG. 1. In the method 500, the term “content hints generated at the display engine” means to include content hints generated by the display engine 155 and/or by the analyzer 210.

The method 500 may start with the display engine 155 retrieving a given image layer in a current frame from a memory (step 510). The display engine 155 or the analyzer 210 generates a content hint for each region of the given image layer in the current frame, when a producer of the given image layer does not generate the content hint. Based on at least content hints generated at the display hardware 155 for the given image layer in the current frame, the display engine 155 makes a determination of whether to skip access to the memory for retrieving each region of each image layer in a next frame that is immediately after the current frame (step 520). The display engine 155 then accesses the memory for the next frame according to the determination (step 530).

The operations of the flow diagram of FIG. 5 have been described with reference to the exemplary embodiment of FIG. 1. However, it should be understood that the operations of the flow diagram of FIG. 5 can be performed by embodiments of the invention other than the embodiment discussed with reference to FIG. 1, and the embodiment discussed with reference to FIG. 1 can perform operations different than those discussed with reference to the flow diagram of FIG. 5. While the flow diagram of FIG. 5 shows a particular order of operations performed by certain embodiments of the invention, it should be understood that such order is exemplary (e.g., alternative embodiments may perform the operations in a different order, combine certain operations, overlap certain operations, etc.).

Various functional components or blocks have been described herein. As will be appreciated by persons skilled in the art, the functional blocks will preferably be implemented through circuits (either dedicated circuits, or general purpose circuits, which operate under the control of one or more processors and coded instructions), which will typically comprise transistors that are configured in such a way as to control the operation of the circuitry in accordance with the functions and operations described herein.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A method for a device to generate blended frames, with each blended frame composed of a plurality of image layers and each image layer composed of a plurality of regions, comprising:
retrieving, by display hardware of the device, a given image layer in a current frame from a memory;
making a determination of whether to skip access to the memory for retrieving each region of each image layer in a next frame that is immediately after the current frame, based on at least content hints generated at the display hardware for the given image layer in the current frame; and
accessing the memory by the display hardware for the next frame according to the determination.

2. The method of claim 1, wherein determining whether to skip access to the memory is based on, at least in part, an indication received by the display engine that the given image layer in the next frame is not updated from the current frame.

3. The method of claim 1, wherein a content hint for each region of each image layer comprises an alpha hint indicating transparency or opaqueness of the region of the image layer.

4. The method of claim 3, further comprising:
skipping access to the memory for a given region of the given image layer in the next frame according to the alpha hint generated by the display engine that indicates the given region of the given image layer in the current frame is transparent.

5. The method of claim 3, further comprising:
skipping access to the memory for a co-located region of a next image layer in the next frame according to the alpha hint generated by the display engine that indicates the given region of the given image layer in the current frame is opaque, wherein the co-located region of the next image layer is directly behind the given region of the given image layer.

6. The method of claim 1, wherein each region of each image layer is further described by a dirtiness hint indicating whether each region of each image layer in the next frame is updated from the current frame.

7. The method of claim 6, wherein determining whether to skip access to the memory is based on one or both of an alpha hint and the dirtiness hint for each region of each image layer, wherein the alpha hint is generated by the display engine.

8. The method of claim 1, wherein each region of each image layer is further described by a constant hint indicating whether each region of each image layer in the next frame has constant pixel values across an entire region.

9. The method of claim 1, wherein determining whether to skip access to the memory is based on a combination of the content hints generated by the display engine and additional content hints generated by software.

10. The method of claim 1, further comprising:
storing the content hints to thereby make the content hints available for subsequent usage by the display hardware and other hardware components in the device.

11. The method of claim 1, further comprising:
analyzing pixel values of the image layers to enable generation of a content hint for each region of the given image layer in the current frame, when a producer of the given image layer does not generate the content hint.

12. A device operative to generate blended frames, with each blended frame composed of a plurality of image layers and each image layer composed of a plurality of regions, comprising:
circuitry that includes a plurality of image producers to produce the image layers;
a memory to store the image layers; and
display hardware coupled to the circuitry and the memory, the display hardware operative to:
retrieve a given image layer in a current frame from the memory;
make a determination of whether to skip access to the memory for retrieving each region of each image layer in a next frame that is immediately after the current frame, based on at least content hints generated at the display hardware for the given image layer in the current frame; and
access the memory for the next frame according to the determination.

13. The device of claim 12, wherein the display engine is operative to skip access to the memory based on, at least in part, an indication received by the display engine that the given image layer in the next frame is not updated from the current frame.

14. The device of claim 12, wherein a content hint for each region of each image layer comprises an alpha hint indicating transparency or opaqueness of the region of the image layer.

15. The device of claim 14, wherein the display engine is operative to skip access to the memory for a given region of the given image layer in the next frame according to the alpha hint generated by the display engine that indicates the given region of the given image layer in the current frame is transparent.

16. The device of claim 14, wherein the display engine is operative to skip access to the memory for a co-located region of a next image layer in the next frame according to the alpha hint generated by the display engine that indicates the given region of the given image layer in the current frame is opaque, wherein the co-located region of the next image layer is directly behind the given region of the given image layer.

17. The device of claim 12, wherein each region of each image layer is further described by a dirtiness hint indicating whether each region of each image layer in the next frame is updated from the current frame.

18. The device of claim 17, wherein the display engine is operative to skip access to the memory based on one or both of an alpha hint and the dirtiness hint for each region of each image layer, wherein the alpha hint is generated by the display engine.

19. The device of claim 12, wherein each region of each image layer is further described by a constant hint indicating whether each region of each image layer in the next frame has constant pixel values across an entire region.

20. The device of claim 12, wherein the display engine is operative to skip access to the memory based on a combination of the content hints generated by the display engine and additional content hints generated by software.

21. The device of claim 12, wherein the display engine is operative to store the content hints to thereby make the content hints available for subsequent usage by the display hardware and other hardware components in the device.

22. The device of claim 12, further comprising: an analyzer coupled to the display engine, the analyzer operative to analyze pixel values of the image layers to enable generation of a content hint for each region of the given image layer in the current frame, when an image producer of the given image layer does not generate the content hint;
